(19) United States
(12) Patent Application Publication
(10) Pub. No.: US 2024/0246416 A1
(43) Pub. Date: Jul. 25, 2024

(54) VEHICLE DISPLAY DEVICE

(71) Applicant: Atieva, Inc., Newark, CA (US)

(72) Inventors: Lucas Jungmann, Newark, CA (US); Richard Chiang, Newark, CA (US)

(21) Appl. No.: 18/561,998

(22) PCT Filed: May 16, 2022
(86) PCT No.: PCT/US2022/072350

§ 371 Date: Nov. 17, 2023

Related U.S. Application Data
(60) Provisional application No. 63/201,874, filed on May 17, 2021.

(51) Int. Cl. B60K 35/22; B60K 35/10; B60K 35/50

(52) U.S. Cl. CPC B60K 35/22; B60K 35/10; B60K 35/50; B60K 2360/1438

(57) ABSTRACT

A vehicle display device can include: a cover glass that is multicurved, wherein the cover glass is free floating and has an exposed glass edge; display modules that each has a free-form shape, the display modules positioned side by side and covered by the cover glass; an active pixel area visible through the cover glass, wherein the active pixel area includes a first area that has touch sensitivity and a second area that does not have touch sensitivity; and a connection portion configured for mounting the vehicle display device to a dashboard so that the vehicle display device floats from the dashboard.

### CROSS-REFERENCE TO RELATED APPLICATION

This application claims priority to U.S. Patent Application No. 63/201,874, filed on May 17, 2021, and entitled “VEHICLE DISPLAY DEVICE,” the disclosure of which is incorporated by reference herein in its entirety.

### TECHNICAL FIELD

This document relates to a vehicle display device.

### BACKGROUND

Electronic displays in automobiles are typically placed in front of the occupant line of sight for ease of viewing and interaction. Electronic displays can be passive display devices or have touchscreen technology for an occupant to interact with the display. Electronic displays in vehicles have typically been rectangular and flat. One problem with flat and rectangular touch-sensitive displays is that due to their flatness they must be placed entirely within arm's reach. Another problem is that they must be packed in a location that does not block visibility for the driver. Traditionally only a single display is laminated behind a single piece of cover glass.

### SUMMARY

In a first aspect, a vehicle display device comprises: a cover glass that is curved; and display modules that each has a free-form shape, the display modules positioned side by side and covered by the cover glass.

In a second aspect, a vehicle display device comprises: a cover glass that is curved, wherein the cover glass is free floating and has an exposed glass edge; and a display module that has a free-form shape.

In a third aspect, a vehicle display device comprises: a cover glass that is curved; a display module that has a free-form shape; and an active pixel area visible through the cover glass, wherein the active pixel area includes a first area that has touch sensitivity and a second area that does not have touch sensitivity.

In a fourth aspect, a vehicle display device comprises: a cover glass that is curved; a display module that has a free-form shape; and a connection portion configured for mounting the vehicle display device to a dashboard so that the vehicle display device floats from the dashboard.

In a fifth aspect, a vehicle display device comprises: a cover glass that is curved, wherein the cover glass is free floating and has an exposed glass edge; and display modules positioned side by side and covered by the cover glass.

In a sixth aspect, a vehicle display device comprises: a cover glass that is curved; display modules positioned side by side and covered by the cover glass; and an active pixel area visible through the cover glass, wherein the active pixel area includes a first area that has touch sensitivity and a second area that does not have touch sensitivity.

In a seventh aspect, a vehicle display device comprises: a cover glass that is curved; display modules positioned side by side and covered by the cover glass; and a connection portion configured for mounting the vehicle display device to a dashboard so that the vehicle display device floats from the dashboard.

In an eighth aspect, a vehicle display device comprises: a cover glass that is curved, wherein the cover glass is free floating and has an exposed glass edge; a display module covered by the cover glass; and an active pixel area visible through the cover glass, wherein the active pixel area includes a first area that has touch sensitivity and a second area that does not have touch sensitivity.

In a ninth aspect, a vehicle display device comprises: a cover glass that is curved, wherein the cover glass is free floating and has an exposed glass edge; a display module covered by the cover glass; and a connection portion configured for mounting the vehicle display device to a dashboard so that the vehicle display device floats from the dashboard.

In a tenth aspect, a vehicle display device comprises: a cover glass that is curved; an active pixel area visible through the cover glass, wherein the active pixel area includes a first area that has touch sensitivity and a second area that does not have touch sensitivity; and a connection portion configured for mounting the vehicle display device to a dashboard so that the vehicle display device floats from the dashboard.

In an eleventh aspect, a vehicle display device comprises: a cover glass that is multicurved; and display modules that each has a free-form shape, the display modules positioned side by side and covered by the cover glass.

In a twelfth aspect, a vehicle display device comprises: a cover glass that is multicurved, wherein the cover glass is free floating and has an exposed glass edge; and a display module that has a free-form shape.

In a thirteenth aspect, a vehicle display device comprises: a cover glass that is multicurved; a display module that has a free-form shape; and an active pixel area visible through the cover glass, wherein the active pixel area includes a first area that has touch sensitivity and a second area that does not have touch sensitivity.

In a fourteenth aspect, a vehicle display device comprises: a cover glass that is multicurved; a display module that has a free-form shape; and a connection portion configured for mounting the vehicle display device to a dashboard so that the vehicle display device floats from the dashboard.

In a fifteenth aspect, a vehicle display device comprises: a cover glass that is multicurved, wherein the cover glass is free floating and has an exposed glass edge; and display modules positioned side by side and covered by the cover glass.

In a sixteenth aspect, a vehicle display device comprises: a cover glass that is multicurved; display modules positioned side by side and covered by the cover glass; and an active pixel area visible through the cover glass, wherein the active pixel area includes a first area that has touch sensitivity and a second area that does not have touch sensitivity.

In a seventeenth aspect, a vehicle display device comprises: a cover glass that is multicurved; display modules positioned side by side and covered by the cover glass; and a connection portion configured for mounting the vehicle display device to a dashboard so that the vehicle display device floats from the dashboard.

In an eighteenth aspect, a vehicle display device comprises: a cover glass that is multicurved, wherein the cover glass is free floating and has an exposed glass edge; a display module that has a free-form shape; and a connection portion configured for mounting the vehicle display device to a dashboard so that the vehicle display device floats from the dashboard.

In a nineteenth aspect, a vehicle display device comprises: a cover glass that is multicurved; an active pixel area visible through the cover glass, wherein the active pixel area includes a first area that has touch sensitivity and a second area that does not have touch sensitivity; and a cover glass that is free floating and has an exposed glass edge.

In a twentieth aspect, a vehicle display device comprises: a cover glass that is multicurved; an active pixel area visible through the cover glass, wherein the active pixel area includes a first area that has touch sensitivity and a second area that does not have touch sensitivity; and a connection portion configured for mounting the vehicle display device to a dashboard so that the vehicle display device floats from the dashboard.

In a twenty-first aspect, a vehicle display device comprises: a cover glass that is multicurved, wherein the cover glass is free floating and has an exposed glass edge; display modules that each has a free-form shape, the display modules positioned side by side and covered by the cover glass; an active pixel area visible through the cover glass, wherein the active pixel area includes a first area that has touch sensitivity and a second area that does not have touch sensitivity; and a connection portion configured for mounting the vehicle display device to a dashboard so that the vehicle display device floats from the dashboard.

### BRIEF DESCRIPTION OF DRAWINGS

FIG. 1 shows a perspective view of a front of an example of a display device for a vehicle.

FIG. 2 shows an example of the display device of FIG. 1 installed in a passenger compartment of a vehicle.

FIG. 3 shows an example of a portion of the housing and cover glass of the display device of FIG. 1.

FIG. 4 shows a perspective view of an interior of the display device of FIG. 1.

FIG. 5 shows a top view of the cover glass of the display device of FIG. 1 and the display modules of FIG. 4.

FIG. 6 shows a perspective view of an example of the cover glass of FIG. 1.

FIG. 7 illustrates an example architecture of a computing device that can be used to implement aspects of the present disclosure.

Like reference symbols in the various drawings indicate like elements.

### DETAILED DESCRIPTION

This document describes examples of systems and techniques for providing improved vehicle display devices. In some implementations, multiple (e.g., three) free-formed and curved display panels are combined behind a single piece of cover glass. For example, this can allow ease of touch access for the occupants as well as maximize road visibility. In some implementations, different displays can be laminated behind a single piece of cover glass. For example, this can allow the implementation to exhibit benefits of each of the display devices. In some implementations, at least one display device (e.g., two) of the multiple display devices can have touch sensitivity, and at least another display device of the multiple display devices (e.g., the one behind the steering wheel that is out of reach by the occupant) may not have touch sensitivity. Each display screen can be independently curved. In some implementations, this can allow the implementation to bring the display into the occupant reach zone differently. For example, this can improve ergonomics and display interactions. Generally, more curvature can increase display complexity, risk and cost; the design can deliberately reduce the complexity of the display(s) where the display device is more curved. In some implementations, the display(s) can be free-formed (e.g., not rectangular in nature) and can conform more freely to the overall shape of the display device. The shape of the display device can be optimized to ensure road visibility and to limit blind spots. The display device can be a self-contained unit that floats above the instrument panel. In some implementations, the display device can be positioned similar to a computer screen on a desk. For example, a display device that is not integrated into the instrument panel can be easier to service and can provide a unique style and look.

Examples herein refer to display devices. A display device visually outputs a graphical user interface for one or more computer devices. A display device can operate according to any of multiple display technologies used for presenting computer-based information. A display device can include a liquid crystal display (LCD), a light-emitting diode (LED) display, and/or a plasma display, to name just a few examples. A display device can be configured for receiving input for the computer device(s). In some implementations, a display device can feature one or more types of technology for detecting contact with, or proximity to, the screen by a user's hand or an implement such as a stylus. A display device can operate according to any of multiple touch-detecting, and/or gesture-recognizing, technologies (collectively “touch sensitivity”). A display device can include a resistive touchscreen, a capacitive touchscreen, and/or a touchscreen based on optical imaging, to name just a few examples. A display device can have any of multiple shapes. In some implementations, a display device has a quadrilateral shape (e.g., rectangular), or a free-form shape, to name just a few examples. A display device can have a substantially flat form factor (e.g., the screen is essentially planar), or a non-flat form factor (e.g., the screen is curved according to one or more radiuses.) Two or more display devices can be positioned according to any of multiple spatial relationships with regard to each other. One display device can be placed substantially above another display device in a vertical direction. One display device can be placed substantially to the side of another display device in a horizontal direction. One display device can be placed diagonally from another display device in any direction. Two or more display devices can be positioned so as to face in a common direction. Two or more display devices can be positioned so as to face in different directions from each other.

Examples herein refer to a display device having a cover glass. As used herein, a cover glass is a transparent substrate. A transparent substrate can be made of, but is not limited to, a glass material. For example, a cover glass can be made from chemically strengthened glass. A cover glass can be planar or non-planar. For example, a cover glass can have a curved shape. A cover glass can be compatible with use of touchscreen technology for allowing a user to make inputs using the cover glass, wherein content is visually presented at the cover glass. In some implementations, the cover glass can facilitate use of capacitive and/or resistive touch sensing, to name just two examples.

Examples herein refer to a cover glass that is curved. As used herein, a curved cover glass is not flat and is characterized as having at least one curvature radius. In some implementations, the curvature radius can refer to the curvature of the cover glass in a horizontal direction (e.g., the curvature can be visible at least in a top view). For example, other components of the display device (e.g., backlight module, LCD module, circuit board) can have curvatures so that these components fit together in combination with the curved cover glass.

Examples herein refer to a cover glass that is multicurved. As used herein, a multicurved cover glass is not flat and is characterized as having multiple curvature radii. The multiple curvature radii refer to the curvatures at different portions of the multicurved cover glass of the display device. For example, a cover glass can be referred to as multicurved when there is a transition portion (e.g., between a pair of the portions having different curvature radii). As another example, a cover glass can be referred to as multicurved when there is no transition portion (e.g., between any pair of the portions having different curvature radii, or otherwise). The multiple curvature radii can be, but are not necessarily, associated with respective display modules of the display device. For each curvature radius of the multiple curvature radii, other components of the curved display device (e.g., backlight module, LCD module, circuit board) can have curvatures that make these components fit together in combination with the portion of the multicurved cover glass.

Examples herein refer to a cover glass that is free floating and that has an exposed glass edge. As used herein, an exposed glass edge is not covered by a frame or bezel, or any part of the housing of the display device or of a dashboard. An exposed glass edge can extend around an entire perimeter of a cover glass, or the exposed glass edge can extend only over one or more portions of the perimeter of the cover glass.

Examples herein refer to a display module that has a free-form shape. As used herein, a display module that has a free-form shape is not rectangular when viewed at a normal angle toward its center, but rather its display area has a different shape. In some implementations, the free-form display area can be a non-rectangular polygon when viewed at a normal angle toward its center. The free-form area can be a trapezoid (e.g., a parallelogram), or an n-gon, where n=5, 6, 7, . . . , to name just a few examples. In some implementations, the free-form display area can have one or more rounded sides.

Examples herein refer to a display device mounted to a dashboard so that the display device floats from the dashboard. As used herein, a display device that floats from the dashboard is self-contained and is not embedded within (e.g., not positioned flush with, or sunk into) the dashboard. For example, the display device is positioned in front of and/or above the dashboard.

Examples herein refer to a substrate being transparent. As used herein, being transparent is used substantially synonymously with being optically clear. As used herein, a substrate (such as an adhesive or a cover glass) is transparent if it has a transmittance within at least part of the visible-light spectrum of at least about 80%. In some implementations, a substrate can be considered transparent if it has a transmittance within most of the visible-light spectrum of at least about 80%.

Examples herein refer to an adhesive used with one or more components of a vehicle display device. As used herein, an adhesive is compatible with the environmental conditions that can occur within vehicles in different situations around the world. In some implementations, the adhesive can be capable of withstanding the environmental testing conditions that may apply to vehicles in one or more geographic regions. Such conditions can relate to durability or performance under different aspects such as temperature ranges, humidity ranges, or exposure to sunlight, to name just a few examples.

Examples herein refer to a vehicle. A vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle. The vehicle can include a passenger compartment accommodating one or more persons. At least one vehicle occupant can be considered the driver; various tools, implements, or other devices, can then be provided to the driver. In examples herein, any person carried by a vehicle can be referred to as a “driver” or a “passenger” of the vehicle, regardless whether the person is driving the vehicle, or whether the person has access to controls for driving the vehicle, or whether the person lacks controls for driving the vehicle.

Examples herein refer to a front, rear, top or a bottom. These and similar expressions identify things or aspects in a relative way based on an express or arbitrary notion of perspective. That is, these terms are illustrative only, used for purposes of explanation, and do not necessarily indicate the only possible position, direction, and so on.

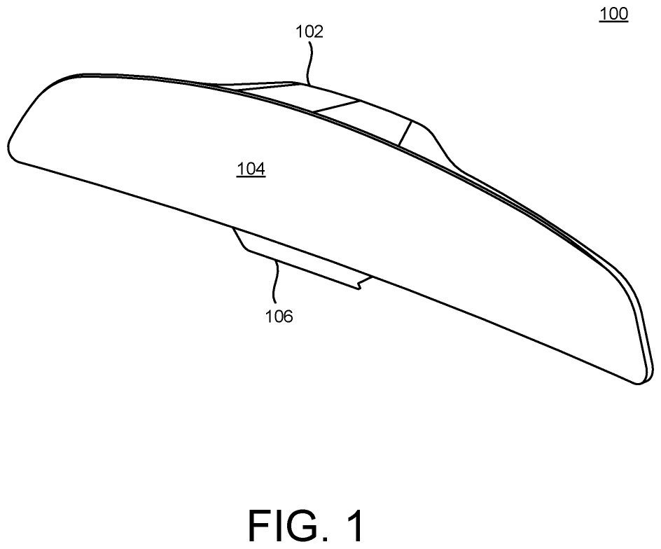

FIG. 1 shows a perspective view of a front of an example of a display device 100 for a vehicle. The display device 100 or any component thereof can be used with one or more other examples described elsewhere herein. In some implementations, the display device 100 can be part of a dashboard of a vehicle. For example, the display device 100 can provide a user interface to an occupant of the vehicle, such as in form of an instrument cluster.

The display device 100 includes a housing 102, a cover glass 104, and a connection portion 106. The housing 102 can form an opening (not visible) into an interior space. The interior space can accommodate components such as a display module. The housing 102 can be made of any suitable material, including, but not limited to, of metal or a polymer material. In some implementations, the housing 102 can be made using a casting process. For example, magnesium or a similar material can be thixomolded into the shape of the housing 102.

The cover glass 104 is positioned at the opening into the interior of the housing 102. The cover glass 104 can provide a view of content presented by a display module within the housing 102. In some implementations, the cover glass 104 facilitates one or more types of user input by way of touchscreen technology, over its entire area or only one or more portions thereof. The cover glass 104 can be curved or multicurved, to name just two examples.

The connection portion 106 can be configured for mounting of the display device 100 onto some structure (e.g., an instrument panel), and for communication between other components elsewhere in the vehicle and the display module and/or a touchscreen component. For example, the connection portion 106 can provide that the display device 100 is positioned in front of and/or above the dashboard (e.g., floating from the dashboard) so as to be easy to see and reach.

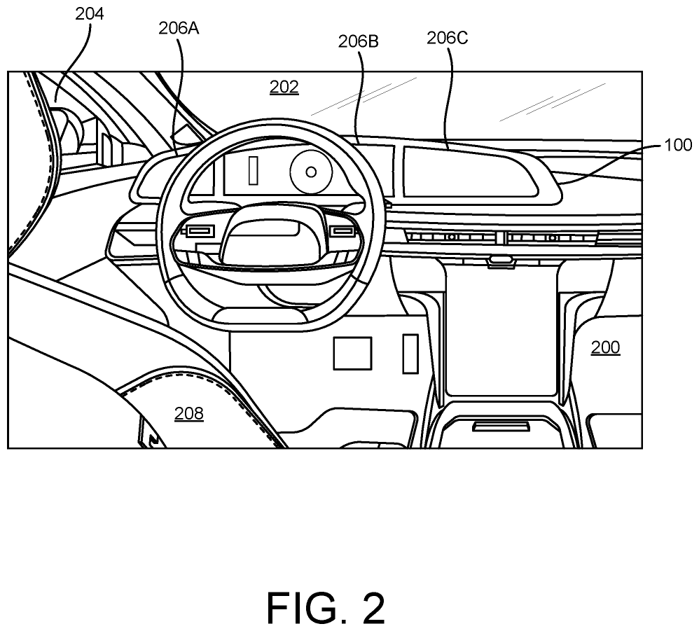

FIG. 2 shows an example of the display device 100 of FIG. 1 installed in a passenger compartment 200 of a vehicle. The passenger compartment 200 here has a windshield 202 and a side window 204. The display device 100 can have a shape that allows flexible use while providing one or more advantages, including, but not limited to, in terms of ergonomics, user friendliness, and/or safety. In some implementations, portions 206A and 206C of the display device 100 can be vertically lower than a portion 206B. For example, this can promote visibility for an occupant in a seat 208. In some implementations, portions 206A and 206C of the display device 100 can be positioned closer to the seat 208 than is the portion 206B. For example, this can promote reachability for the occupant in the seat 208 when the portions 206A and 206C have touch sensitivity (e.g., the portion 206B may not have touch sensitivity). In some implementations, the display device 100 floats from the instrument panel of the passenger compartment 200. For example, this can allow the display device 100 to better absorb impact force from an occupant in case of a collision event.

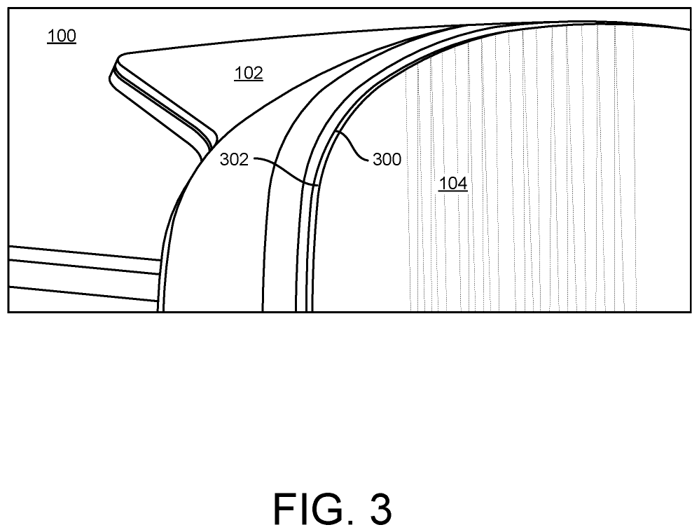

FIG. 3 shows an example of a portion of the housing 102 and cover glass 104 of the display device 100 of FIG. 1. The housing 102 has an edge 300 around the opening to the interior. The cover glass 104 has an edge 302. However, the edge 300 of the housing does not cover the edge 302 of the cover glass 104. Rather, the cover glass 104 here is a free-floating cover glass that does not have a bezel or frame, such that the edge 302 is not encapsulated but is an exposed glass edge. For example, the edge 302 can have a rounded profile. In some implementations, the edge 302 is an exposed glass edge around an entire perimeter of the cover glass 104. In some implementations, a portion of the perimeter of the cover glass 104 can be bounded by a frame or bezel, and the edge 302 can then be an exposed glass edge throughout the remaining perimeter of the cover glass 104.

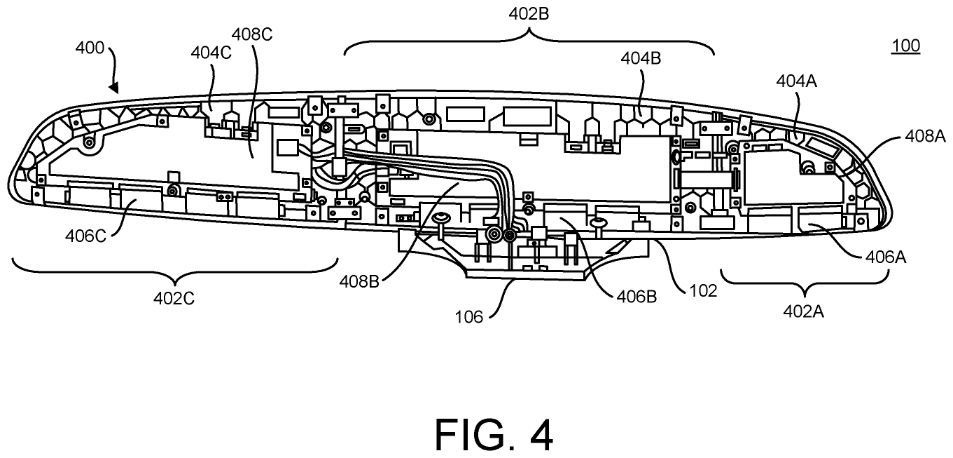

FIG. 4 shows a perspective view of a rear of the display device 100 of FIG. 1. Here, an interior 400 of the display device 100 is visible. The housing 102 can include a removable cover covering the interior 400 which is here omitted for visibility. The housing 102 can include the connection portion 106 and one or more display modules. Here, the display device 100 includes display modules 402A-402C, respectively. The display modules 402A-402C can be oriented in any of multiple configurations. In some implementations, the display modules 402A-402C are positioned according to the portions 206A-206C (FIG. 2) of the display device 100. Here, the display modules 402A-402C are arranged side by side horizontally within the display device 100. For example, from the perspective of an occupant, the display module 402A can be referred to as a left display module, the display module 402B can be referred to as a center display module, and the display module 402C can be referred to as a right display module. That is, in a left-side drive vehicle, the display module 402A can be situated nearest the driver side window of the display modules 402A-402C. One or more of the display modules 402A-402C can have a free-form shape. One or more of the display modules 402A-402C can have a cover glass that is curved. One or more of the display modules 402A-402C can have a cover glass that is multicurved.

Each of the display modules 402A-402C can include electronic components and other devices for its operation. Here, the display module 402A includes a backlight module 404A with light-emitting diodes (LEDs) 406A, and also a circuit board 408A. The display module 402B includes a backlight module 404B with LEDs 406B, and also a circuit board 408B. The display module 402C includes a backlight module 404C with LEDs 406C, and also a circuit board 408C. One or more of the display modules 402A-402C can feature touch sensitivity.

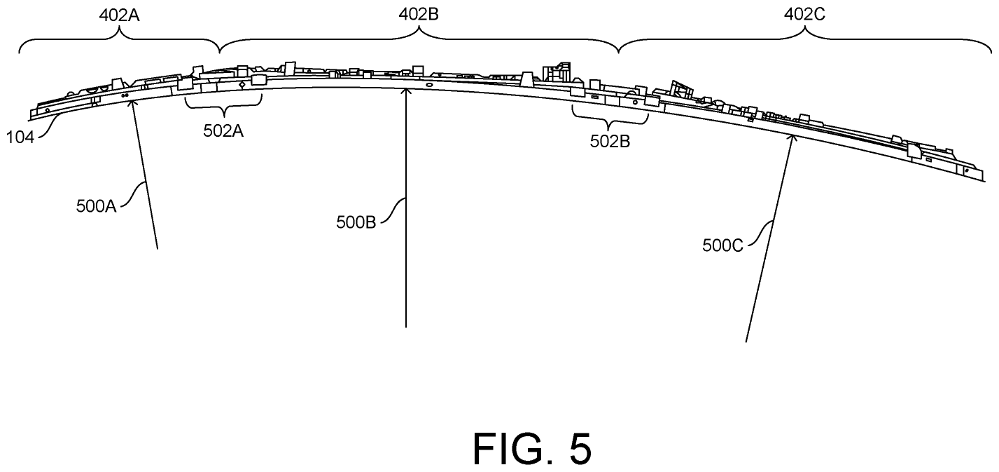

FIG. 5 shows a top view of the cover glass 104 of the display device 100 of FIG. 1 and the display modules 402A-402C of FIG. 4. The cover glass 104 is here multicurved. A curvature radius 500A is associated with a leftmost portion of the cover glass 104 in this view. A curvature radius 500B is associated with a center portion of the cover glass 104 in this view. A curvature radius 500C is associated with a rightmost portion of the cover glass 104 in this view. One or more of the curvature radii 500A-500C can be a different length than another of the curvature radii 500A-500C. In some implementations, the curvature radius 500A is longer or shorter than at least one of the curvature radii 500B-500C. For example, the curvature radius 500A can be on the order of about 600 to about 1000 millimeters (mm), such as about 800 mm. In some implementations, the curvature radius 500B is longer or shorter than at least one of the curvature radii 500A and 500C. For example, the curvature radius 500B can be on the order of about 1000 to about 3000 mm, such as about 2000 mm. In some implementations, the curvature radius 500C is longer or shorter than at least one of the curvature radii 500A-500B. For example, the curvature radius 500C can be on the order of about 1000 to about 3000 mm, such as about 2000 mm. Other combinations and/or curvature radii can be used. In some implementations, the cover glass 104 has only a single curvature radius.

Any of the curvature radii 500A-500C can be associated with respective curvature radii of the components of one or more display modules. In some implementations, the curvature radius 500A corresponds to the display module 402A. For example, components of the display module 402A (e.g., the backlight module 404A, LEDs 406A, and circuit board 408A in FIG. 4) can each have a curvature radius defined based on the curvature radius 500A.

In some implementations, the curvature radius 500B corresponds to the display module 402B. For example, components of the display module 402B (e.g., the backlight module 404B, LEDs 406B, and circuit board 408B in FIG. 4) can each have a curvature radius defined based on the curvature radius 500B.

In some implementations, the curvature radius 500C corresponds to the display module 402C. For example, components of the display module 402C (e.g., the backlight module 404C, LEDs 406C, and circuit board 408C in FIG. 4) can each have a curvature radius defined based on the curvature radius 500C.

One or more of the portions of the cover glass 104 having any of the curvature radii 500A-500C can be associated with a transition portion. Here, a transition portion 502A is positioned between the curvature radii 500A-500B. In some implementations, the transition portion 502A can have a different curvature radius than the curvature radii 500A-500B, or can have no curvature. For example, the transition portion 502A can have a curvature radius that is between the curvature radii 500A-500B. Here, a transition portion 502B is positioned between the curvature radii 500B-500C. In some implementations, the transition portion 502B can have a different curvature radius than the curvature radii 500B-500C, or can have no curvature. For example, the transition portion 502B can have a curvature radius that is between the curvature radii 500B-500C. Other combinations can be used.

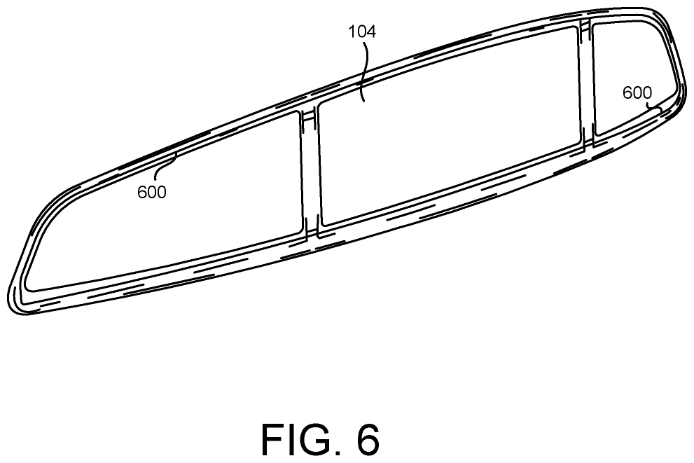

FIG. 6 shows a perspective view of an example of the cover glass 104 of FIG. 1. The cover glass 104 can be provided with a mask 600. The mask 600 can be made of any suitable material having sufficiently low (e.g., substantially zero) transparency. In some implementations, the mask 600 can define regions relating to the active pixel area(s) of one or more display modules such that the active pixel areas are visible through the cover glass 104. In some implementations, the active pixel area can include a first area that has touch sensitivity and a second area that does not have touch sensitivity. In some implementations, the active pixel area can correspond to the portions 206A-206C (FIG. 2) of the display device 100.

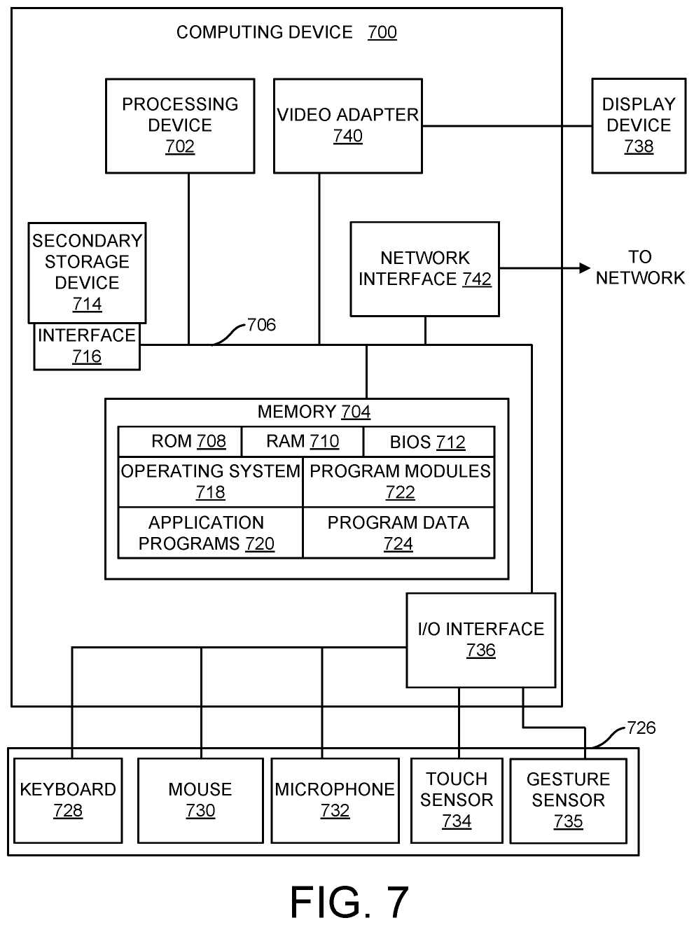

FIG. 7 illustrates an example architecture of a computing device 700 that can be used to implement aspects of the present disclosure, including any of the systems, apparatuses, and/or techniques described herein, or any other systems, apparatuses, and/or techniques that may be utilized in the various possible embodiments.

The computing device illustrated in FIG. 7 can be used to execute the operating system, application programs, and/or software modules (including the software engines) described herein.

The computing device 700 includes, in some embodiments, at least one processing device 702 (e.g., a processor), such as a central processing unit (CPU). A variety of processing devices are available from a variety of manufacturers, for example, Intel or Advanced Micro Devices. In this example, the computing device 700 also includes a system memory 704, and a system bus 706 that couples various system components including the system memory 704 to the processing device 702. The system bus 706 is one of any number of types of bus structures that can be used, including, but not limited to, a memory bus, or memory controller; a peripheral bus; and a local bus using any of a variety of bus architectures.

Examples of computing devices that can be implemented using the computing device 700 include a desktop computer, a laptop computer, a tablet computer, a mobile computing device (such as a smart phone, a touchpad mobile digital device, or other mobile devices), or other devices configured to process digital instructions.

The system memory 704 includes read only memory 708 and random access memory 710. A basic input/output system 712 containing the basic routines that act to transfer information within computing device 700, such as during start up, can be stored in the read only memory 708.

The computing device 700 also includes a secondary storage device 714 in some embodiments, such as a hard disk drive, for storing digital data. The secondary storage device 714 is connected to the system bus 706 by a secondary storage interface 716. The secondary storage device 714 and its associated computer readable media provide nonvolatile and non-transitory storage of computer readable instructions (including application programs and program modules), data structures, and other data for the computing device 700.

Although the example environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media. For example, a computer program product can be tangibly embodied in a non-transitory storage medium. Additionally, such computer readable storage media can include local storage or cloud-based storage.

A number of program modules can be stored in secondary storage device 714 and/or system memory 704, including an operating system 718, one or more application programs 720, other program modules 722 (such as the software engines described herein), and program data 724. The computing device 700 can utilize any suitable operating system, such as Microsoft Windows™, Google Chrome™ OS, Apple OS, Unix, or Linux and variants and any other operating system suitable for a computing device. Other examples can include Microsoft, Google, or Apple operating systems, or any other suitable operating system used in tablet computing devices.

In some embodiments, a user provides inputs to the computing device 700 through one or more input devices 726. Examples of input devices 726 include a keyboard 728, mouse 730, microphone 732 (e.g., for voice and/or other audio input), touch sensor 734 (such as a touchpad or touch sensitive display), and gesture sensor 735 (e.g., for gestural input). In some implementations, the input device(s) 726 provide detection based on presence, proximity, and/or motion. In some implementations, a user may walk into their home, and this may trigger an input into a processing device. For example, the input device(s) 726 may then facilitate an automated experience for the user. Other embodiments include other input devices 726. The input devices can be connected to the processing device 702 through an input/output interface 736 that is coupled to the system bus 706. These input devices 726 can be connected by any number of input/output interfaces, such as a parallel port, serial port, game port, or a universal serial bus. Wireless communication between input devices 726 and the input/output interface 736 is possible as well, and includes infrared, BLUETOOTH® wireless technology, 802.11a/b/g/n, cellular, ultra-wideband (UWB), ZigBee, or other radio frequency communication systems in some possible embodiments, to name just a few examples.

In this example embodiment, a display device 738, such as a monitor, liquid crystal display device, light-emitting diode display device, projector, or touch sensitive display device, is also connected to the system bus 706 via an interface, such as a video adapter 740. In addition to the display device 738, the computing device 700 can include various other peripheral devices (not shown), such as speakers or a printer.

The computing device 700 can be connected to one or more networks through a network interface 742. The network interface 742 can provide for wired and/or wireless communication. In some implementations, the network interface 742 can include one or more antennas for transmitting and/or receiving wireless signals. When used in a local area networking environment or a wide area networking environment (such as the Internet), the network interface 742 can include an Ethernet interface. Other possible embodiments use other communication devices. For example, some embodiments of the computing device 700 include a modem for communicating across the network.

The computing device 700 can include at least some form of computer readable media. Computer readable media includes any available media that can be accessed by the computing device 700. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 700.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 7 is also an example of programmable electronics, which may include one or more such computing devices, and when multiple computing devices are included, such computing devices can be coupled together with a suitable data communication network so as to collectively perform the various functions, methods, or operations disclosed herein.

The terms “substantially” and “about” used throughout this Specification are used to describe and account for small fluctuations, such as due to variations in processing. For example, they can refer to less than or equal to ±5%, such as less than or equal to ±2%, such as less than or equal to #1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. (canceled)

2. (canceled)

3. (canceled)

4. A vehicle display device comprising:
a cover glass that is curved;
a display module that has a free-form shape; and
a connection portion configured for mounting the vehicle display device to a dashboard so that the vehicle display device floats from the dashboard.

5. (canceled)

6. (canceled)

7. (canceled)

8. (canceled)

9. (canceled)

10. (canceled)

11. (canceled)

12. A vehicle display device comprising:
a cover glass that is multicurved, wherein the cover glass is free floating and has an exposed glass edge; and
a display module that has a free-form shape.

13. (canceled)

14. (canceled)

15. (canceled)

16. (canceled)

17. (canceled)

18. (canceled)

19. (canceled)

20. A vehicle display device comprising:
a cover glass that is multicurved;
an active pixel area visible through the cover glass, wherein the active pixel area includes a first area that has touch sensitivity and a second area that does not have touch sensitivity; and
a connection portion configured for mounting the vehicle display device to a dashboard so that the vehicle display device floats from the dashboard.

21. (canceled)

22. The vehicle display device of claim 20, wherein the cover glass is free floating and has an exposed glass edge that extends only over one or more portions of an entire perimeter of the cover glass.

23. The vehicle display device of claim 20, wherein the cover glass is free floating and has an exposed glass edge that extends around an entire perimeter of the cover glass.

24. The vehicle display device of claim 20, wherein the active pixel area is included in a display module that has a free-form shape.

25. The vehicle display device of claim 24, wherein the free-form shape is a non-rectangular polygon when viewed at a normal angle toward a center of the display module.

26. The vehicle display device of claim 25, wherein the non-rectangular polygon is a trapezoid or an n-gon, where n=5, 6, 7, . . . .

27. The vehicle display device of claim 4, wherein the cover glass is multicurved and wherein no transition portion exists between two portions of the cover glass having different curvature radii.

28. The vehicle display device of claim 4, wherein the cover glass is free floating and has an exposed glass edge.

29. The vehicle display device of claim 4, wherein the display module comprises an active pixel area visible through the cover glass, wherein the active pixel area includes a first area that has touch sensitivity and a second area that does not have touch sensitivity.

30. The vehicle display device of claim 29, wherein the vehicle display device provides a user interface for an occupant in a seat of the vehicle, and wherein a first portion of the display module that includes the first area is positioned closer to the seat than is a second portion of the display module that includes the second area.

31. The vehicle display device of claim 4, wherein the free-form shape is a non-rectangular polygon when viewed at a normal angle toward a center of the display module.

32. The vehicle display device of claim 4, further comprising a housing with an edge around an opening to an interior of the housing, wherein an edge of the housing does not cover an edge of the cover glass.

33. The vehicle display device of claim 12, further comprising a housing that includes a connection portion configured for mounting the vehicle display device to a dashboard so that the vehicle display device floats from the dashboard.

34. The vehicle display device of claim 12, further comprising an active pixel area visible through the cover glass, wherein the active pixel area includes a first area that has touch sensitivity and a second area that does not have touch sensitivity.

35. The vehicle display device of claim 12, wherein the display module is a first display module, and wherein vehicle display device comprises multiple display modules including the first display module, the multiple display modules positioned side by side and covered by the cover glass.
